(19) United States
(12) Patent Application Publication
(10) Pub. No.: US 2002/0014572 A1
(43) Pub. Date: Feb. 7, 2002

(54) Method and apparatus for joining material

(76) Inventor: Charles Wade Albritton, Germantown, WI (US)

Correspondence Address: MICHAEL BEST & FRIEDRICH, LLP, 100 E WISCONSIN AVENUE, MILWAUKEE, WI, 53202, US

(21) Appl. No.: 09/827,299

(22) Filed: Apr. 5, 2001

Related U.S. Application Data
(60) Provisional application No. 60/194,708, filed on Apr. 5, 2000.

(51) Int. Cl. F16M 1/00

(52) U.S. Cl. 248/674

(57) ABSTRACT

In some preferred embodiments of the present invention, elements to be joined with adhesive have brackets attached thereto and are drawn together by a fastening or drawing device tightened upon the brackets. In such embodiments, the brackets are preferably secured to the surfaces of the elements by adhesive covering at least part of the base of the brackets and adjacent surfaces of the elements being joined. The bracket bases can have sharp edges enabling release of the brackets by being tapped. Some preferred embodiments employ adhesive “rivets” passed though apertures in one element and attached to an adjacent element. The adhesive defining each adhesive rivet preferably covers an area around its associated aperture so that when the adhesive hardens, the cap or head of the adhesive rivet holds the apertured element to the adjacent element even if the adhesive does not bond or bonds poorly to the apertured element.

### FIELD OF THE INVENTION

The present invention relates to methods and apparatuses for attaching elements to a surface and for fastening elements together. More specifically, the present invention relates to methods and apparatuses for joining elements to a surface, to each other, or to a surface and to each other using an adhesive material.

### BACKGROUND OF THE INVENTION

The use of adhesive material to join elements together provides a number of advantages over other fastening elements and methods. For example, assembly speed can often be significantly increased by using adhesive. In addition, adhesive can be used where fasteners would otherwise be visible, and can help to provide a desired appearance to a finished product. Also, adhesive is often employed where insufficient room exists for installing or tightening fasteners. Unfortunately, because the ability of many adhesives to adhere to a surface of material normally varies from material to material, the use of adhesive is usually limited by the type of material being joined or fastened.

Two material types that can be relatively difficult to join with adhesive are Corian® and Zodiac® (E. I. du Pont de Nemours and Company). For example, there is currently no adhesive that reliably joins Corian® or Zodiac® material to metal. Those adhesives that adhere well to Corian® or Zodiac® do not normally adhere well to metal, and vice versa. This has significantly limited the use of Corian® and Zodiac® in many applications, such as on metal cabinets, range hoods, counter tops, and the like. Instead, when a metallic appearance is undesirable for such articles, they have been painted to correspond to the surrounding décor or have been made from other materials. However, metal is frequently most desirable because of its durability and cleanability, and the appearance of a painted metal surface is often not preferred. Metal offers another advantage of providing a fire resistant surface lining thus permitting the use of a flammable material outer coating near external heat sources or over electrical enclosures.

Another problem with Corian® and Zodiac® is the difficulty often encountered with joining pieces of Corian® or Zodiac® material in an end-to-end or other abutting fashion. The pieces of Corian® and Zodiac® material can sometimes slip or shift with respect to one another while the adhesive sets. In addition, although compressive force upon the joint being bonded is highly desirable, maintaining sufficient compression until the adhesive material sets can be difficult.

The above discussion is with regard to joining Corian® and Zodiac® material to a metal surface, and is presented by way of example only. Although the problems discussed above are relevant to elements being joined that are made of any material or combination of materials, Corian®-to-Corian® and Corian®-to-metal attachments are discussed in greater detail below due to the particularly difficult nature of such attachments. References herein to Corian® are understood to also encompass Zodiac® and comparable “solid surface” materials.

In light of the problems and limitations of the prior art described above, a need exists for an apparatus and method for attaching elements to one another and/or to a surface using adhesive in which the adhesive may or may not be well suited for attachment to different material types, a strong and reliable connection is produced, the materials of the elements or element and surface being joined may be different (such as a Corian®-to-metal connection) or the same (such as a Corian®-to-Corian® connection), and the elements or element and surface being joined can be properly secured while the adhesive sets. Each preferred embodiment of the present invention achieves one or more of these results.

### SUMMARY OF THE INVENTION

In some preferred embodiments of the present invention, elements to be joined with adhesive have brackets attached thereto and are drawn together by a fastening or drawing device attached to and tightened upon the brackets. The brackets can be used to secure co-planar elements together and in some embodiments can secure elements that are at any angle with respect to one another.

The elements to be joined with adhesive can be any shape and size and have abutting surfaces which are joined with the adhesive. The elements can be made of any material or combination of materials. However, the present invention provides outstanding advantages in the connection of natural and synthetic solid surface materials to each other and to other materials such as metals, woods, stone, ceramics, composites, and the like. Examples of natural solid surface materials include granite and marble. Examples of synthetic solid surface materials include acrylic polymer materials such as Corian® and Zodiac® (E. I. du Pont de Nemours and Company), and polyester/acrylic polymer materials. The present invention also provides outstanding advantages in the attachment of natural and synthetic solid surface materials to metal and other materials, especially in cases where adhesives do not readily bond to both the solid surface materials and metal or other materials. As discussed above, these latter connections have either been impossible to produce with adhesive or do not result in a strong and reliable connection.

Where brackets are employed to draw elements together for joining as described above, the brackets are preferably secured to the surfaces of the elements by adhesive. Preferably, the adhesive covers at least part of the base of the brackets and adjacent surfaces of the elements being joined. In some embodiments, the bracket bases have sharp edges that preferably are adjacent to and face the adhesive. Therefore, the brackets can be released from the surfaces of the elements by being tapped to force the sharp edges into and/or under the adhesive.

Each bracket preferably has at least one tang extending vertically above the bracket base and which can be connected to a fastening or drawing device. The fastening or drawing device can therefore be connected to the tangs of brackets on adjacent elements to be joined and can be tightened to bring the elements together (preferably into compression while adhesive between the elements sets). The fastening or drawing device is a bolt and a nut in one preferred embodiment, but can be a clamp, turnbuckle, or other device in alternative embodiments.

To connect one element to an adjacent element, some preferred embodiments of the present invention employ one or more adhesive rivets passed though respective apertures in one element and attached to the adjacent element. The adhesive defining an adhesive rivet preferably covers an area around its associated aperture so that when the adhesive hardens, the cap or head of the adhesive rivet holds the apertured element to the adjacent element even if the adhesive does not bond or bonds poorly to the apertured element. In this manner, a strong connection can be made between elements to which adhesive does not adhere well.

Adhesive rivets within apertures as just described can be used to bond elements together and in some embodiments can be used in conjunction with the brackets described above to construct a joint between elements. Such rivets can be used to secure elements to a frame, to reinforce corners and edges of elements, to strengthen or stiffen elements (e.g., panels, beams, etc.), and the like.

More information and a better understanding of the present invention can be achieved by reference to the following drawings and detailed description.

### BRIEF DESCRIPTION OF THE DRAWINGS

The present invention is further described with reference to the accompanying drawings, which show preferred embodiments of the present invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the present invention.

In the drawings, wherein like reference numerals indicate like parts:

FIGS. 1A-1C illustrate the use of angle brackets and a bolt to secure a pair of Corian® sheets to each other;

FIGS. 2 and 3 illustrate the angle bracket as attached to Corian® material, including a supply of a Corian® adhesive;

FIGS. 4 and 5 illustrate the use of a bolt and the pair of angle brackets to secure two pieces of Corian® material together;

FIG. 6 is a magnified view illustrating the action of the Corian® adhesive to prevent the angle bracket from being pulled from the surface of the Corian® base material;

FIG. 7A-7C are illustrations of a second embodiment of the present invention in which Corian glue “rivets” are used to secure Corian® material to a metal skeleton; and

FIGS. 8-11 illustrate the attachment of the Corian® base material to a sheet metal skeleton by the Corian® rivets and further illustrates the failure mode of the Corian® rivets.

### DETAILED DESCRIPTION OF THE PREFERRED EMBODIMENTS

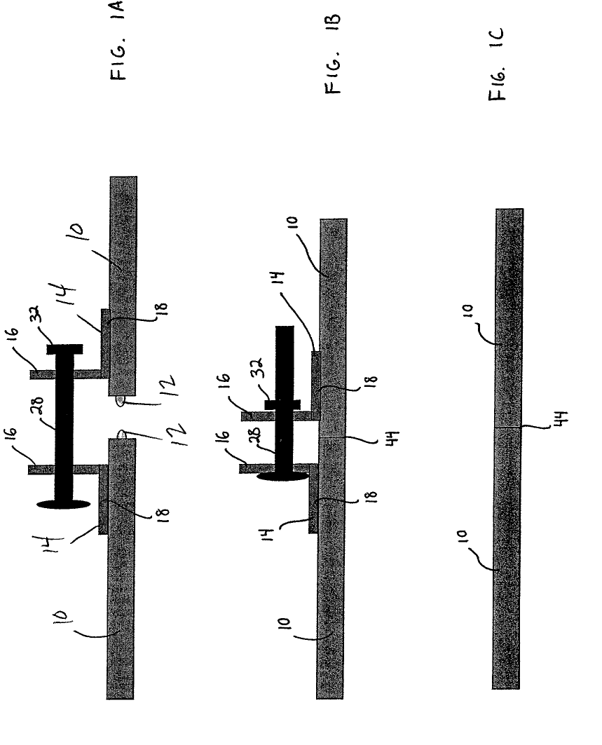

Referring first to FIGS. 1A-1C, two pieces of Corian® material are shown in successive stages of connection according to one preferred embodiment of the present invention. In this case, edge surfaces of two Corian® pieces 10 are being connected with adhesive 12. Although the pieces shown are relatively flat with relatively flat edges, it should be noted that the present invention can be practiced with pieces 10 having any shape (e.g., thickness, width, length, edge shape, and the like). Best results are obtained with significant amounts of contact area between the abutting faces of the pieces 10 being connected.

With continued reference to FIGS. 1A-1C, a bead of adhesive 12 is applied at the facing surfaces of the Corian® pieces 10 in any conventional manner, but can instead be applied to only one of the facing surfaces for later transfer to the other facing surface when the pieces 10 are brought together. The adhesive 12 can instead be applied as a plurality of dots on either or both of the facing surfaces, in a pattern or layer, or in any other manner desired.

In some preferred embodiments of the present invention such as that shown in the figures, the material bonding the pieces 10 together is an adhesive material. However, cohesive bonding material can instead be used to bond the pieces 10 together, as well as combinations of adhesive and cohesive bonding material. Depending upon the type of bonding material used, the adhesive, cohesive, and adhesive and cohesive bonding material can cure or set by drying, through a catalytic reaction with air or with a catalyst exposed to or mixed with the bonding material, by pressure contact, by exposure to heat, or in a number of other conventional manners. Preferably, the Corian® pieces 10 of the illustrated preferred embodiment are joined by an acrylic resin, Corian® resin, neoprene-based panel adhesive, melamine glue, or by any other conventional adhesive capable of reliably bonding to Corian®. Some highly preferred Corian® adhesives that can be used are made with the same material used to make Corian®.

To assist in positioning and holding the pieces 10 while the adhesive, cohesive, or adhesive/cohesive bonding material sets, two angle brackets 14 are preferably attached to the surface of each piece 10. Specifically, the angle brackets 14 are preferably held in place upon the surface of the pieces 10 by adhesive material as will be described in greater detail below. The brackets 14 are preferably made of aluminum or steel, but can instead be made of any preferably resilient material such as other metals, plastic, composites, and the like.

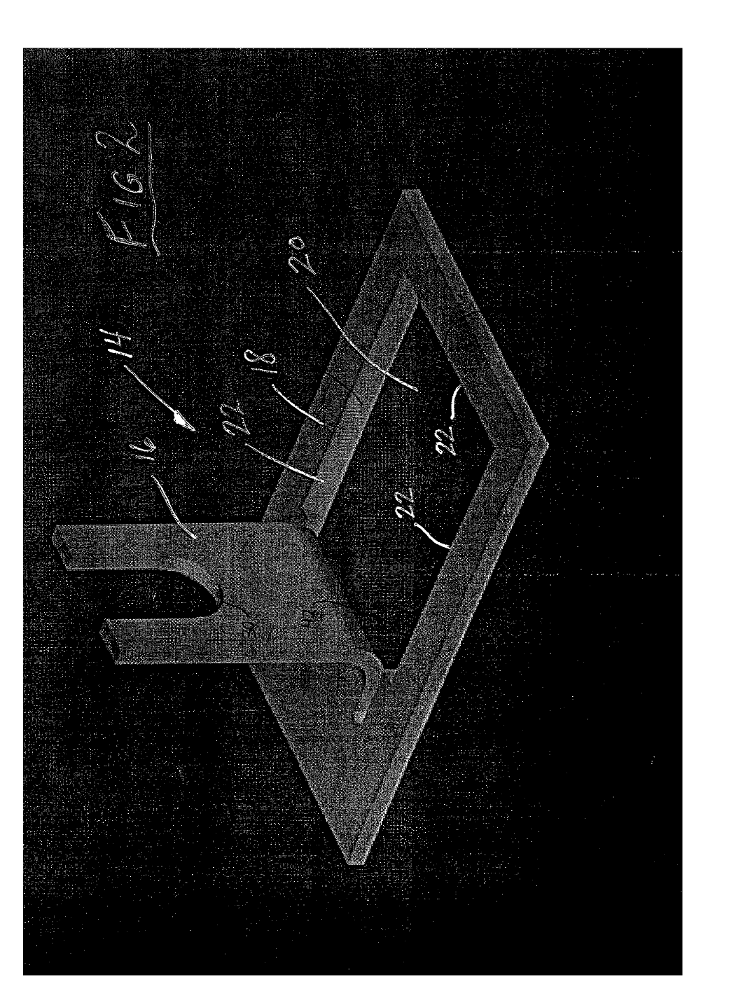

In some preferred embodiments of the present invention, each bracket 14 has a tang 16 extending from the surface of the piece 10 to which it is attached. Referring now to FIG. 2, the tangs 16 are preferably vertical or generally vertical, and extend from a horizontal base portion 18 of the bracket 14.

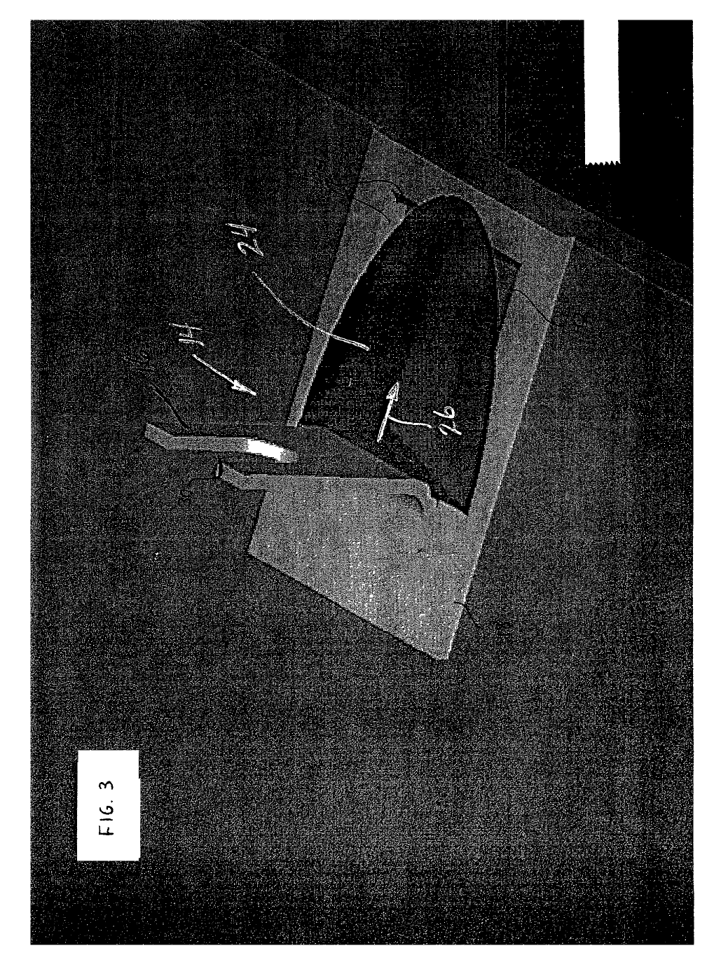

The horizontal base portion 18 preferably includes an opening 20 (see FIG. 2) defined by a series of edges 22. Preferably, the opening 20 serves as a receptacle into which adhesive material 24 is placed as best shown in FIGS. 3-6. This adhesive material 24 is therefore located upon the surface of the piece 10 to be joined and upon the base portion 18 of the bracket 14. In this manner, the bracket 14 is secured in place upon the surface of the piece 10. The adhesive material 24 can be any of the bonding materials described above with reference to bead 12. Most preferably, the adhesive material 24 is the same material used to bond the edges of the pieces 10 together.

It should be noted that other base shapes are possible over which adhesive can be applied to secure the base portion 18 of the bracket 14 to the piece 10. By way of example only, the base portion 18 can instead be U-shaped, in the shape of a cross or a T (with the tang 16 extending from the center thereof, for example), and the like. In each case, adhesive preferably covers at least a portion of the base 18 and the adjacent surface of the piece 10. Although still other base portion shapes are possible and fall within the spirit and scope of the present invention, an opening in the base 18 as shown in FIGS. 3-6 is preferred. In this regard, the opening need not necessarily have a rectangular shape as shown in the figures, but can instead have any other shape desired, such as square, round, oval, triangular, irregular, and other shapes.

In some preferred embodiments, at least one edge of the base 18 is relatively sharp, and faces the adhesive 24 applied thereover or adjacent thereto. Preferably, these sharp edges 42 are also adjacent to the surface of the underlying piece 10, although the edges can be shaped to present a sharp point or blade a distance above the piece 10. In the illustrated preferred embodiment, three of the edges 22 defining each opening 20 are sharp edges 42 adjacent to the surface of the underlying piece 10. The sharp edges act as blades, and are preferably at an acute angle with respect to the underlying piece and/or the base 18.

The sharp edges 42 enable a user to break the cured or set adhesive 24 in order to remove the bracket 14 from the piece 10. Specifically, because the sharp edges 42 preferably face the adhesive 24 as described above, an impact upon the bracket 14 in the direction of the sharp edges 42 can cut into and/or beneath the adhesive 24 and can thereby release the bracket 14. Because the sharp edges 42 are preferably adjacent to or flush with the underlying piece 10, clean removal of the bracket 14 and adhesive 24 is possible without leaving any adhesive residue upon the surface of the pieces 10. Even where the sharp edges 42 are not immediately adjacent to or flush with the surface of the underlying piece 10 and even in those cases where the brackets 14 do not have sharp edges 42 as just described, clean release of the bracket 14 is still possible due to the shear force exerted by the bracket 14 upon the adhesive 24 when the bracket 14 is laterally impacted.

With the foregoing in mind, it will be apparent to one with ordinary skill in the art that the sharp edges 42 employed in different bracket base shapes are preferably located facing and beneath or immediately adjacent to the adhesive 24 holding the bracket 14 to the pieces 10. For example, a square base 18 without any openings could have one sharp edge 42 over which the adhesive 24 is applied and hardens, after which time impact in the direction of the sharp edge 42 causes the sharp edge 42 to cut into (or beneath) and release the hardened adhesive 24 and bracket 14. Although one such sharp edge 42 on a bracket 14 could perform the releasing function described above, multiple sharp edges 42 oriented in different directions are possible and enable release of the bracket 14 by impact upon the bracket 14 from multiple angles if desired. For example, the opening 20 of the bracket 14 illustrated in FIGS. 3-6 has two sharp edges 42 facing each other on opposite sides of the adhesive 24 (one on each side of the opening 20) and one sharp edge 42 nearest to the joint between the pieces 10. Impact upon the bracket 14 on either side or on the end adjacent to the joint between the pieces 10 will therefore cause release of the adhesive 24 and bracket 14 from the piece 10.

It should be noted that although one or more sharp edges 42 are preferred on the base 18 of the bracket 14, the bracket 14 can still be released without such edges in other embodiments (e.g., with sufficient side impact to shear the adhesive 24 holding the base 18 to the surface of the piece 10).

Each of the brackets 14 illustrated in the figures is preferably about 1½″ (3.8 cm) and 1″ (2.5 cm) wide, and in other embodiments can be any size and shape desired as described in greater detail above. The brackets 14 and edges 22, 42 thereof can be formed in any conventional manner, such as by being stamped, machined, extruded, pressed, cast, and the like. The sharp edges 42 (if used) can also be made in any conventional manner, such as by being cut or stamped from the base 18 or by being machined on the base 18. In some highly preferred embodiments, the sharp edges 42 are produced by being sheared from the base 18 as the tang 16 is formed from the base 18. Still other manners of making the bracket and edges 22, 42 are possible, are well known in the art, and fall within the spirit and scope of the present invention.

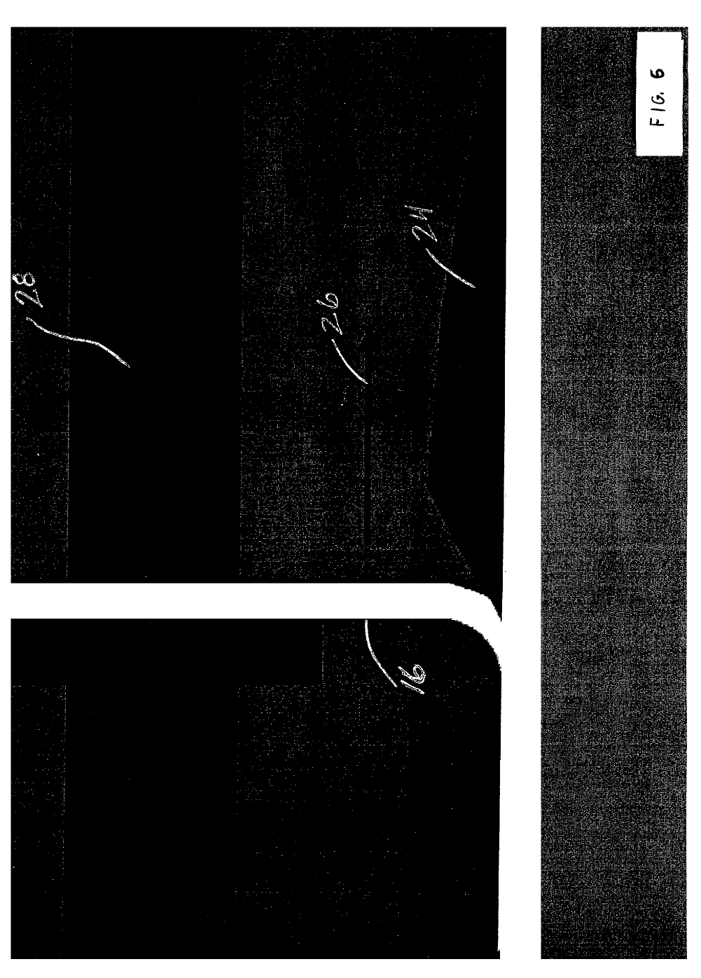

As described above, each bracket 18 preferably has a tang 16 extending vertically therefrom. A primary purpose of the tang 16 is to provide a connection point on the piece 10 being joined for use in holding the piece 10 in place while the adhesive 12 between the pieces 10 dries, cures, or otherwise sets. In some embodiments such as the illustrated preferred embodiment, the tang 16 also functions as a dam or wall adjacent to the adhesive 24 holding the bracket 14 to the piece 10. With reference to FIG. 6, this adhesive 24 in some preferred embodiments is applied unevenly upon the base 18 of the bracket 14. Specifically, the adhesive 24 adjacent to the tang 16 is thicker than in other areas over the bracket 14. Although more adhesive 24 adjacent to the tang 16 is preferred, it should be noted that the adhesive 24 can be applied upon the base 18 of the bracket 14 and upon the surface of the piece 10 uniformly, irregularly, or in any other manner desired. The ramped shape of the adhesive 24 in FIG. 6 is illustrated because of the advantages this shape offers as will now be described.

Because the tang 16 is preferably employed as a connection point for the piece 10 being joined, force is exerted upon the tang 16. Such force can be exerted from any of a number of different angles upon the tang 16. In some highly preferred embodiments, a primary force upon the tang 16 during joining operations is in a direction toward the joint 44 between the pieces 10. This force is preferably transmitted to the base 18 of the bracket 14, through the adhesive 24 on the base 18 and underlying surface, and to the piece 10 being joined. Accordingly, the sharp edges 42 of the base 18 are preferably oriented at least partially away (e.g., at least 45 degrees away, more preferably at least 75 degrees away, and most preferably at least 90 degrees away) from a direction facing the joint 44. Force upon the bracket 14 during joining operations will therefore not shear the adhesive 24 holding the bracket 14 to the piece 10. In other embodiments, the sharp edges 42 face or substantially face the joint 44 between the pieces 10, but are either insufficiently sharp to release the bracket adhesive 24 during normal joining operations or are not normally exposed to high shear forces during such operations. However, sharp edges turned at least partially away from the direction of force upon the tang 16 (e.g., away from the joint 44 in the illustrated preferred embodiment) are preferred.

With continued reference to FIGS. 2 and 6, the side of the bracket opening 18 defined by the tang 16 is preferably in contact with the adhesive 24 holding the bracket 14 to the piece 10. When force is exerted upon the tang 16 in a direction 26 toward the joint 44 during joining operations of the pieces 10 (as described below), the bracket adhesive 24 helps to prevent release of the bracket 14, acting as a stop against which the bracket 14 presses. In other embodiments of the present invention, other parts of the bracket 14 (e.g., a side of the bracket 14, an end of the bracket 14, and the like) can press against the bracket adhesive 24 in a similar manner to prevent the bracket 14 from shearing off of the surface of the piece 10. The bracket adhesive 24 is therefore preferably selected to be largest at or near this point. However, as mentioned above, the bracket adhesive 24 can be any thickness and can be distributed across the bracket 14 and the underlying and surrounding surfaces in any manner desired.

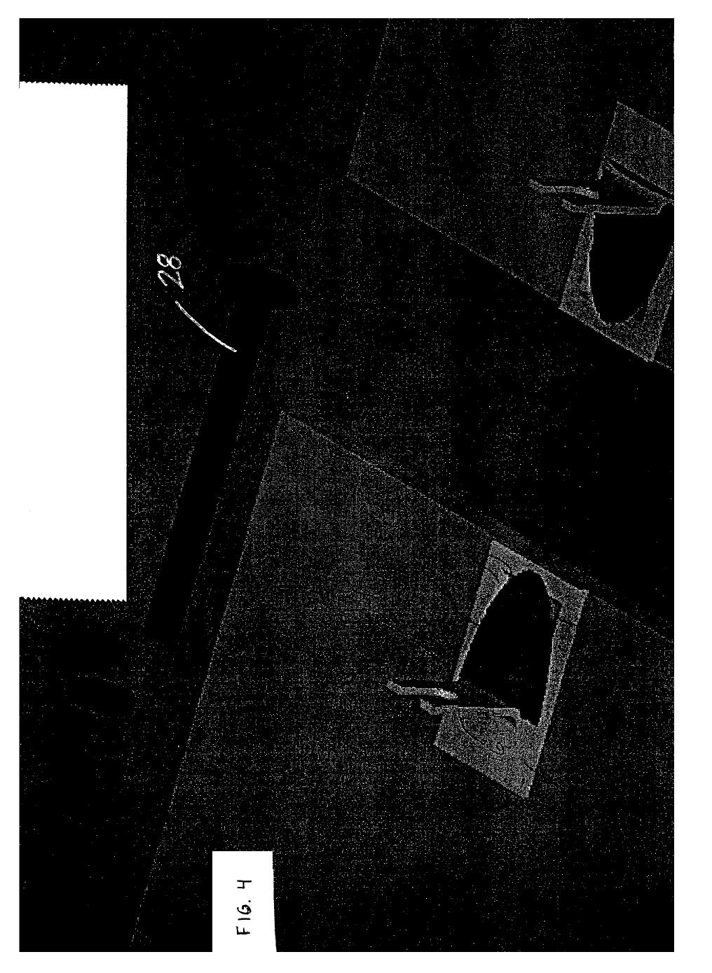

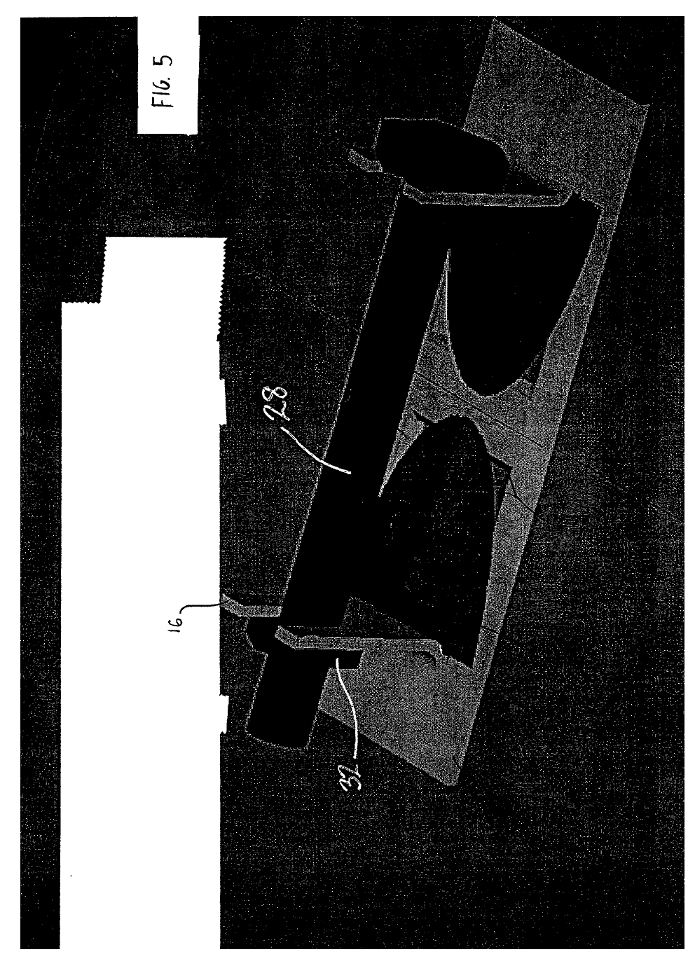

Referring now to FIGS. 4 and 5, a bracket 14 is preferably attached near the edge surface of each piece 10 to be joined, and is preferably attached to the pieces 10 with adhesive 24 in the manner described above. When the pieces 10 are brought adjacent to or in abutting relationship with one other, a bolt 28 can be placed within U-shaped apertures 30 in each of the tangs 16. Once the bolt 28 is in place, a nut 32 can be tightened such that the two pieces of Corian® material 10 are pulled together. Compressive force is thereby applied to each of the brackets 14 in the direction of arrow 26 of FIG. 6.

It will be appreciated by one having ordinary skill in the art that different tang shapes and manners of connection to a fastener 28 are possible and fall within the spirit and scope of the present invention. By way of example only, the tang 16 can instead have a closed hole through which the bolt 28 is passed to connect tangs 16 together. Like the U-shaped aperture 30 above, the hole can receive the bolt 28 in one place on the tang 16 or can be elongated or otherwise shaped to permit the bolt 28 to be located at different positions in the tang 16. For example, the hole can be elongated, forked, star-shaped, comb-shaped, and the like, thereby permitting the bolt 28 to be located in different positions in the tangs 16. Other embodiments of the present invention employ tangs 16 having multiple holes or apertures for the same purpose. The ability of a user to locate the bolt 28 in multiple positions with respect to the tang 16 and bracket 14 can be useful for different applications, where an obstruction between brackets 14 exist, to connect multiple fasteners between brackets 14 if desired, and the like.

As another example, the tang 16 can be a post, pin, wall, or any other element preferably extending from the base 18 of the bracket 14. In this regard, the tang 16 can be a separate element attached to the base 18 in any conventional manner (such as by welding, brazing, gluing, press-fitting, a threaded connection, by one or more clamps, screws, rivets, or other conventional fasteners, and the like) or can be integral with the base 18 as described above.

By virtue of its use as a connection point for the bracket 14 and piece 10 being joined, the form and shape of the tang 16 is preferably dependent at least partially upon the type of fastener employed to draw and hold adjacent pieces 10 together. An aperture in the tang 16 is well-suited for a bolt 28 and nut 30 fastener, but can also be used with other types of conventional drawing and fastening devices. In other embodiments, a clamp fitted over a pair of tangs 16 on adjacent pieces 10 can be tightened to draw and compress the pieces 10 together. Any type of conventional clamp could be employed, such as a hand screw clamp, ratchet clamp, bar clamp, cam clamp, and the like. Where clamps are used to draw the tangs 16 together, the tangs 16 do not necessarily need apertures, and could take the form of posts or walls extending from the bases 18 of the brackets 14. In still other embodiments, one or more tumbuckles, elastic bands, ratchet straps, winches, or other conventional fastening and/or drawing devices can be attached to the tangs 16 for biasing the brackets 14 together. Each of these alternative devices can connect to, press against, pull, or otherwise exert force upon the tangs 16 in a number of different manners based upon the type of connection to the tangs 16.

Vertically oriented tangs 16 are employed in some preferred embodiments of the present invention. Although the tangs 16 can be perpendicular to the bases 18 of the brackets 14, this relationship between the tangs 16 and bases 18 is not required. Instead, the tangs 16 can be oriented at any other angle with respect to the bases 18 and to the joint 44 between the pieces 10. By way of example only, it may be desirable to employ a tang 16 directed away from the joint 44 to place the tang 16 more in compression along its length, such as in cases where a clamp is placed over the tang 16 and exerts a pushing force upon the tang 16 when tightened. As another example, the tang 16 can be directed toward the joint 44 to place the tang 16 more in tension along its length, such as in cases where an elastic band is connected to the tangs 16 and exerts a pulling force upon each tang 16. Accordingly, the tangs 16 can be at an acute angle with respect to the base 18 if desired.

It will be appreciated that the brackets 14 of the present invention can be connected to a fastening or drawing device having no tangs 16. Specifically, rather than employ an element that extends vertically from the base 18, the brackets 14 can each have an aperture or recess in the base 18 into which a fastening or drawing device is received prior to being tightened. When tightened, the fastening or drawing device could exert force upon a wall of the aperture to draw the bracket 14 and connected piece 10 as described above.

The brackets 14 are preferably attached to adjacent edges of the pieces 10 to be joined as shown in FIGS. 1 and 3-5. Locating the brackets 14 in this manner generally enables faster and easier connection of the pieces 10. However, it should be noted that the brackets 14 can be attached in any desired location on the pieces 10 and relative to one another. Also, although the same bracket type is illustrated on both pieces 10 connected in the figures, the brackets 14 on either side of the joint 44 need not necessarily be identical.

The brackets 14 can be employed to construct a joint between co-planar or substantially co-planar pieces 10 as shown in FIGS. 1 and 3-5, and can also be used to construct joints between pieces 10 at angles with respect to one another. Any angle between pieces 10 is possible. However, the fastening or drawing device used and the form and shape of the tangs 16 and their connection to the fastening or drawing device can be determined by the angle of the joint desired.

After the adhesive 12 between the pieces 10 has set, the brackets 14 can be removed from the pieces by being tapped as described above, thereby shearing the adhesive 24 holding the brackets 14 to the pieces 10. The brackets 14 can be tapped from any angle that generates force of the sharp edges 42 (if used) upon the adhesive 24, and most preferably are tapped in a direction perpendicular or substantially perpendicular to the sharp edges 42 of the brackets 14.

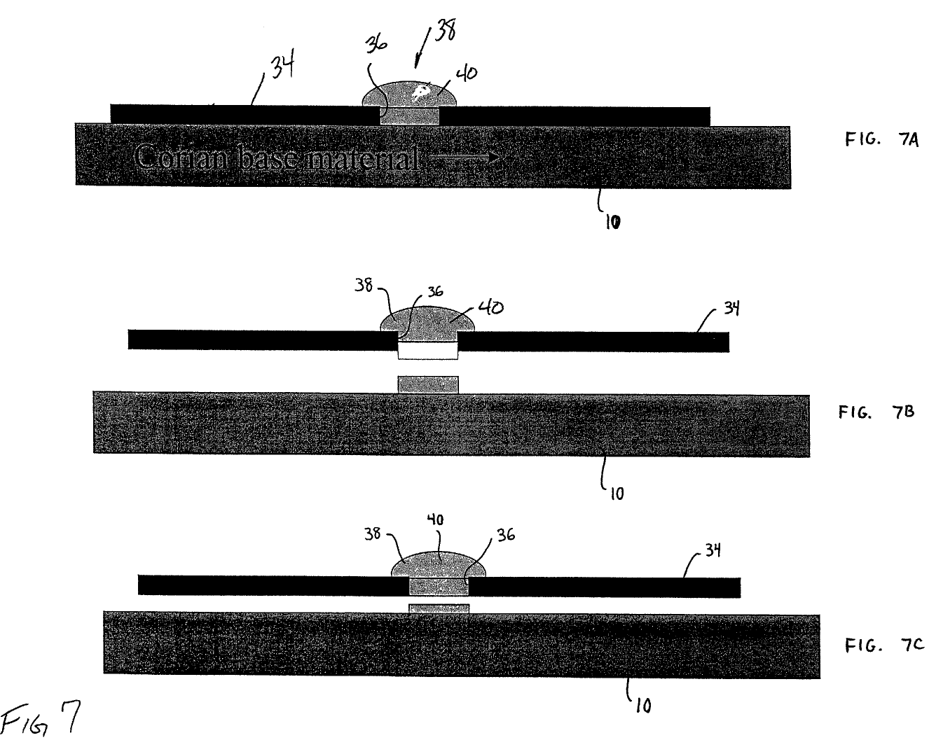

Referring now to FIG. 7A, another manner of employing adhesive to secure a piece 10 is illustrated. FIG. 7A illustrates a case in which adhesive does not bond well to one of the surfaces being bonded (although cases in which the adhesive bonds well to both surfaces are also possible). In the illustrated example, a piece of Corian® 10 is attached to a sheet of metal 34. Although other applications exist as described above, the sheet of metal 34 is a frame of a range hood which is covered by Corian® 10. This application is particularly demanding due to the exposure of the range hood to higher temperatures. As also described in the Background of the Invention above, metal and Corian® are not well suited for attachment together using adhesive in a conventional manner.

It should be noted that the pieces 10, 34 being connected can be made of the same or different material. In addition, the pieces 10, 34 can be made from or include any type of material desired, including without limitation Corian® and other closed-surface materials, metal, wood, stone, ceramic, composite material, and the like. Also, although a sheet and panel 10, 34 are illustrated in FIG. 7A, the present invention can be employed with materials having any dimensions, such as a strip attached to a panel, a sheet attached to a block, and the like.

With continued reference to FIG. 7A, the sheet of metal 34 is attached to the underlying Corian® material 10 by an adhesive “rivet” 38 passed through an aperture 36 in the sheet 34. The aperture 36 can be created in any manner, including without limitation by stamping, punching, molding, casting, machining (drilling, cutting, etc.), and the like. The aperture 36 is preferably round, but can instead take any shape desired, such as an elongated slot, an aperture in the shape of a square, oval, rectangle, star, cross. Any number of apertures 36 can be employed as desired to connect the sheet 10 and panel 34, and can be arranged randomly or in any pattern on the sheet 34. Also, the apertures 36 can be located in any place where connection points are desired between the sheet 34 and the underlying material 10. For example, the apertures 36 can be located near edges or comers of the sheet 34 and underlying material 10 or in locations subject to higher or cyclical stress.

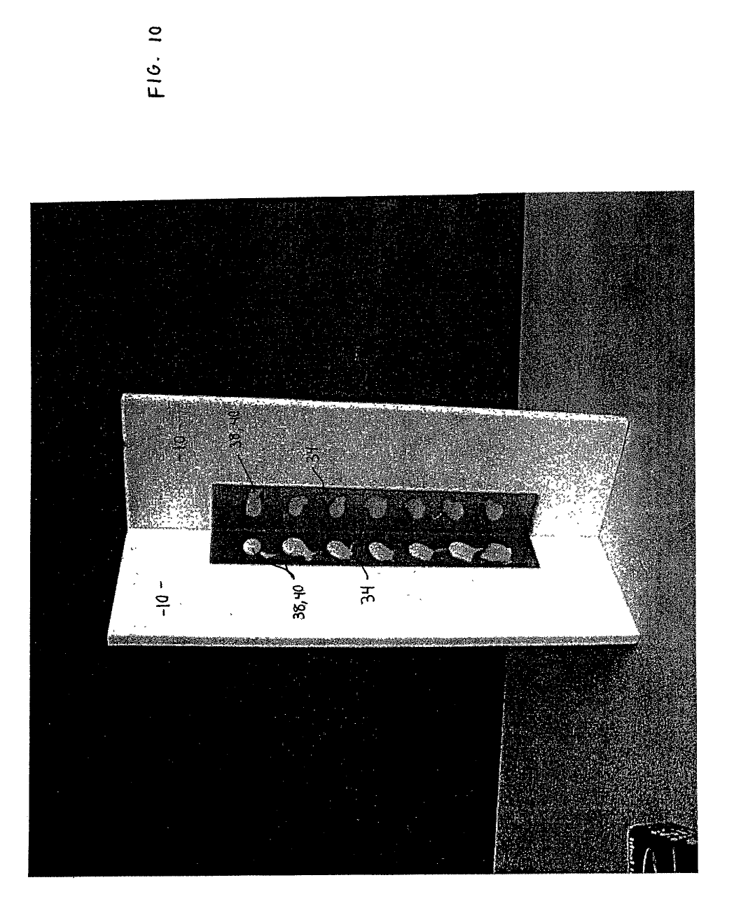

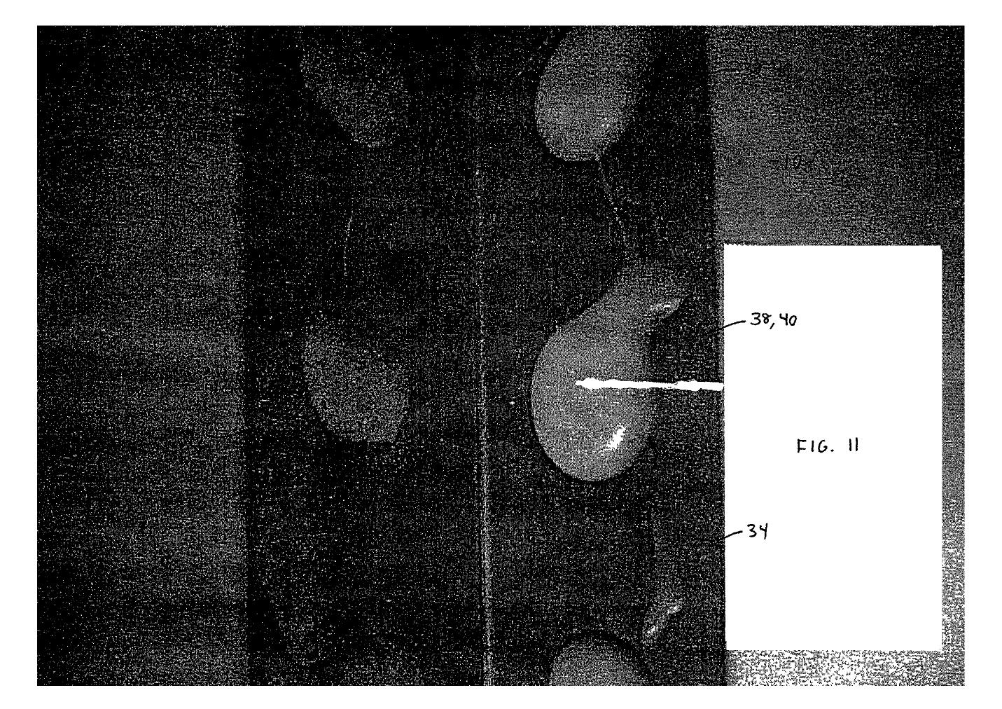

The adhesive 38 is preferably the same adhesive described above with reference to the connection illustrated in FIGS. 1-6. To make the “rivet” connections described above, adhesive is applied to the underlying material 10 (preferably through the aperture 36 in the sheet 34) and covers at least a portion of the surrounding aperture 36 to form a rivet cap 40. The rivet cap 40 can be round as shown in the figures or can take any other shape desired, such as square or oval shapes or irregular shapes as shown in FIGS. 10 and 11. In other embodiments, a layer of adhesive material is applied over one or more apertures 36 and the areas surrounding the apertures 36. After hardening, the rivet cap 40 holds the sheet 34 to the underlying material 10 even if the adhesive does not bond or does not bond well to the sheet 34.

The adhesive bond of the adhesive “rivets” 38 to the underlying material (e.g., Corian® in the illustrated preferred embodiment) is preferably stronger than the adhesive rivet itself, and is therefore unlikely to fail prior to failure of the rivets 38 themselves. Failure of such rivets 38 can be at any location along the rivet 38, such as at a location between the sheet 34 and the underlying material 10 or at a location flush with the underside of the sheet 34 as shown in FIGS. 7B and 7C. Rivet failures in such cases can leave residual rivet material on the underlying material 10 or on the sheet 34. Preferably, this residual material remains adhered to these surfaces in the event of rivet failure.

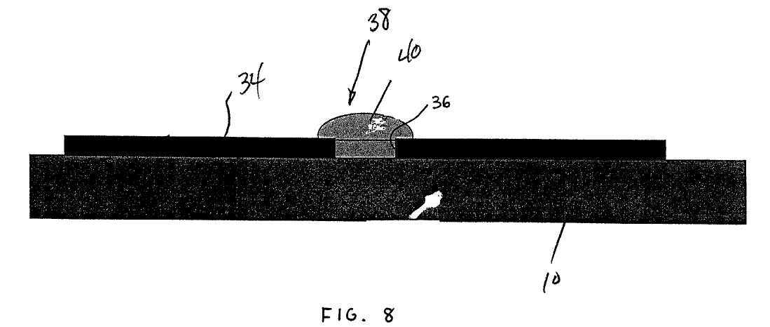

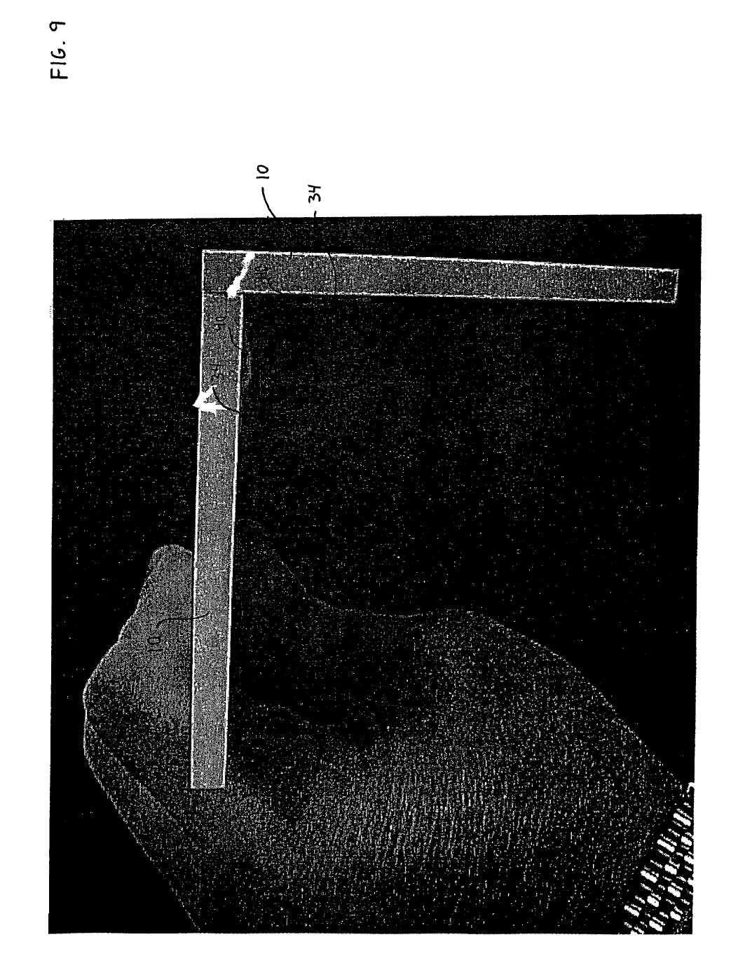

As can be understood with reference to FIGS. 8-11, the adhesive rivet 38 allows sheets and panels to be fixed to underlying elements, such as Corian® to a sheet metal skeleton. Other applications include attaching a bracket or other fixture to a surface as shown in FIG. 8, attaching an angled frame member to adjacent elements which form a corner (e.g., to reinforce the corner and to distribute stress away from the corner) as shown in FIGS. 9-11, reinforcing a joint such as those described above with reference to FIGS. 1-7, attaching a reinforcing or stiffening member to a panel or sheet, and the like. In those cases were the apertured sheet, bracket, or other element is attached with rivets to pieces forming a joint, the joint can have adhesive between the facing edges of the pieces and can be constructed in the manner described above with reference to FIGS. 1-7. Otherwise, the joint can be constructed without such adhesive between the facing edges. Also, any of the joints between pieces described herein can be constructed with any desired angle. A joint between substantially co-planar pieces is illustrated in FIGS. 1-7, and a joint between pieces at right angles with respect to one another is shown in FIGS. 9-11. However, other angles are possible and can be constructed using the brackets 14 described above, using riveted connecting members as also described above, or using both brackets 14 and riveted connecting members.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

I claim:

1. A coupling apparatus in combination with elements defining a joint between the elements, comprising:
a first bracket coupled to a first element with bonding material and releasable from the first element by impact upon the first bracket, the first bracket having a base and a tang extending from the base;
a second bracket coupled to a second element with bonding material; and
a fastener coupled to the second bracket and to the tang of the first bracket, the fastener extending across the joint defined between the first and second element and exerting a force upon each bracket in a direction toward the joint.

2. The apparatus as claimed in claim 1, wherein the fastener is adjustable to draw the first and second brackets and the first and second elements together.

3. The apparatus as claimed in claim 1, wherein the bonding material coupling the first bracket to the first element covers at least part of the base of the first bracket and adjacent surfaces of the first element.

4. The apparatus as claimed in claim 3, wherein the base of the first bracket has a blade facing the bonding material coupling the first bracket to the first element.

5. The apparatus as claimed in claim 1, wherein the base has an aperture defined therein in which is received the adhesive coupling the first bracket to the first element.

6. The apparatus as claimed in claim 1, further comprising an aperture in the tang in which is received the fastener.

7. The apparatus as claimed in claim 1, wherein the fastener is a threaded bolt and nut.

8. The apparatus as claimed in claim 1, wherein the first element comprises a closed-surface material.

9. A bracket assembly for coupling a first element to a second element, the bracket assembly comprising:
a base having at least two edges;
a tang extending away from the base; and
bonding material located over at least a portion of the base and coupling the base to the first element;
wherein one of the edges is a blade facing the bonding material and capable of shearing the bonding material to release the base from the first element.

10. The bracket assembly as claimed in claim 9, further comprising an aperture defined in the tang adapted to receive a fastener therein.

11. The bracket assembly as claimed in claim 10, further comprising an aperture defined in the base in which is received the bonding material and through which the bonding material is coupled to the first element.

12. The bracket assembly as claimed in claim 11, wherein the blade is an edge of the aperture.

13. The bracket assembly as claimed in claim 9, wherein the bonding material is thicker adjacent to the tang than in locations disposed from the tang.

14. A method of coupling a first element to a second element, comprising:
coupling a bracket to the first element with an amount of bonding material,
coupling a fastener to a tang on the bracket;
drawing the first element toward the second element with the fastener;
coupling the first element to the second element; and
tapping the bracket to shear the bracket from the first element.

15. The method as claimed in claim 14, wherein coupling the bracket to the first element includes applying the bonding material in an aperture in a base of the bracket.

16. The method as claimed in claim 14, wherein coupling the fastener to the tang on the bracket includes receiving the fastener in an aperture in the tang.

17. The method as claimed in claim 14, wherein drawing the first element toward the second element with the fastener includes adjusting the fastener.

18. The method as claimed in claim 14, wherein coupling the first element to the second element includes coupling the first element to the second element with bonding material between the first and second elements.

19. The method as claimed in claim 14, wherein tapping the bracket to shear the bracket includes forcing a blade on the bracket toward the bonding material to shear the bonding material from the first element.

20. The method as claimed in claim 14, wherein the first element comprises a closed-surface material.

21. A structure assembled with adhesive, the structure having:
a first element with an aperture therethrough, the first element having a first side and a second side;
a second element adjacent to the second side of the first element;
an adhesive rivet coupled to the second element and extending through the aperture in the first element, the adhesive rivet having a cap located on the first side of the first element retaining the first element adjacent to the second element.

22. The structure as claimed in claim 21, wherein the second element comprises a closed-surface material.

23. The structure as claimed in claim 21, wherein the second element comprises a material selected from one of Corian® and Zodiac®.

24. The structure as claimed in claim 22, wherein the first element comprises metal.

25. The structure as claimed in claim 21, wherein the cap of the rivet covers a surface of the first side of the first element adjacent to the aperture.

26. A method of coupling a first element to a second element, comprising:
providing a first element having first and second surfaces on opposite sides thereof;
placing the first surface of the first element adjacent to the second element;
applying adhesive through an aperture in the first element to a surface of the second element;
bonding the adhesive to the surface of the second element;
at least partially filling the aperture in the first element with the adhesive;
forming a cap of adhesive on the second surface of the first element adjacent to the aperture; and
hardening the adhesive.

27. The method as claimed in claim 26, wherein the second element comprises a closed-surface material.

28. The structure as claimed in claim 26, wherein the second element comprises a material selected from one of Corian® and Zodiac®.

29. The method as claimed in claim 26, wherein the first element comprises metal.
